(19) United States
(12) Patent Application Publication
(10) Pub. No.: US 2022/0332981 A1
(43) Pub. Date: Oct. 20, 2022

(54) HOT MELT TAPE AND MANUFACTURING AND USING METHOD THEREOF

(71) Applicant: Kenner Material & System Co., Ltd., Taoyuan City (TW)

(72) Inventors: Hung-Wei Pan, Taoyuan City (TW); Tai-Shen Hsiao, Taoyuan City (TW); Chin-Huei Yen, Taoyuan City (TW)

(21) Appl. No.: 17/711,635

(22) Filed: Apr. 1, 2022

(30) Foreign Application Priority Data
Apr. 16, 2021 (TW) 110113679

(51) Int. Cl. C09J 7/35; C09J 7/24; C09J 7/38

(52) U.S. Cl. CPC C09J 7/35; C09J 7/243; C09J 7/387; C09J 2301/122; C09J 2301/162; C09J 2301/302; C09J 2301/304; C09J 2453/00; C09J 2423/041; C09J 2423/101; C09J 2425/001; C09J 2433/001

(57) ABSTRACT

The present disclosure provides a hot melt tape at least including a substrate, an adhesive layer, and an anti-sticking layer, wherein the anti-sticking layer is adjacent to the adhesive layer and is the outermost layer of the hot melt tape. The hot melt tape may be used to seal objects, and preferably is made of a multilayer co-extrusion process. The anti-sticking layer prevents the hot melt tape from sticking the objects without needing a release film, and the hot melt tape can be directly heated during sealing the objects.

### CROSS-REFERENCE TO RELATED APPLICATIONS

The entire contents of Taiwan Patent Application No. 110113679, filed on Apr. 16, 2021, from which this application claims priority, are expressly incorporated herein by reference.

### BACKGROUND OF THE INVENTION

### 1. Field of the Invention

The present invention relates to a hot melt tape suitable for being used in a packaging system to seal objects such as food, medicine, or components.

### 2. Description of Related Art

FIG. 1 shows a packaging configuration 1 of the prior art. The packaging configuration 1 includes a base 10 having one or more recesses 102, and an object 11 can be placed in each of the recesses 102. In addition, a sealing tape 12 is used to seal the one or more recesses 102. The sealing tape 12 is usually multi-layered and includes a bottom layer (typically a hot melt pressure sensitive adhesive) at its outermost surface for in contact with the base 10. The sealing tape 12 contacts a flat portion 103 of the base 10 on which heat and/or pressure is exerted so as to seal the one or more recesses 102.

Referring to FIG. 1, in the subsequent manufacturing or shipping process, the package configuration 1 may be at a higher temperature, for example, a temperature exceeding 60° C. At this time, the bottom layer of the sealing tape 12 may have high viscosity due to high temperature, so that the object 11 may be stuck to the sealing tape 12. As a result, as the sealing tape 12 is torn off, the one or more objects 11 are not retained within the recesses 102 and are taken away together with the sealing tape 12.

In order to avoid sticking, the outer surface of the sealing tape 12 may further include a separable film, commonly referred to as a release film, also known as a peeling film or an isolation film. Generally, in order to obtain a slight and appropriate release force after contact with various hot melt pressure sensitive adhesives under limited conditions, the release film is plasma treated, or fluorine-coated, or coated with a silicone release agent on the surface of the film material. The release film can also include a substrate. Before the sealing procedure, the release film must be peeled off first. As a result, the conventional sealing tape 12 or hot melt tape with hot-melt pressure-sensitive adhesives cannot overcome the problem that the objects may stick to the tape at high temperature.

### SUMMARY OF THE INVENTION

An object of this invention is to provide a hot-melt tape and method thereof for being used in a packaging system to seal objects such as food, medicine, or components.

Some examples of the present invention provide a hot melt tape including at least a base layer, an adhesive layer, and an anti-sticking layer. Preferably, the hot-melt tape is multi-layered and is formed by a co-extrusion process. The anti-sticking layer can function as a release film. It not only prevents the hot melt tape from sticking the objects, but also avoid the sticking between the adhesive layer and the base layer during production and transportation. The hot-melt tape can be directly heated during the sealing of objects without removing the anti-sticking layer.

The hot melt tapes of this invention provide excellent anti-stick properties by a structure having the adhesive layer and the anti-sticking layer on one side or both sides. In a preferred embodiment, the hot melt tape has high heat resistance and is insoluble in hot water. In some embodiments, the adhesive layer is sufficiently rigid to facilitate the use and handling of the hot melt tape. In addition, the manufacturing of the hot melt tape has high yield, does not require an additional coating process, and greatly reduces the emission of volatile organic compounds.

### BRIEF DESCRIPTION OF THE DRAWINGS

FIG. 1 shows a conventional packaging configuration.

FIG. 2 is a schematic cross-sectional view showing a hot melt tape in accordance with an embodiment of the present invention.

FIG. 3 is a schematic cross-sectional view showing a hot melt tape in accordance with another embodiment of the present invention.

FIG. 4 is a schematic cross-sectional view showing a hot melt tape in accordance with another embodiment of the present invention.

FIG. 5 is a schematic cross-sectional view showing a hot melt tape in accordance with another embodiment of the present invention.

FIG. 6 is a schematic cross-sectional view showing a hot melt tape in accordance with another embodiment of the present invention.

FIG. 7 is a schematic cross-sectional view showing a hot melt tape in accordance with another embodiment of the present invention.

### DETAILED DESCRIPTION OF THE PREFERRED EMBODIMENT

Reference will now be made in detail to those specific embodiments of the invention. Examples of these embodiments are illustrated in accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well-known process operations and components are not described in detail in order not to unnecessarily obscure the present invention.

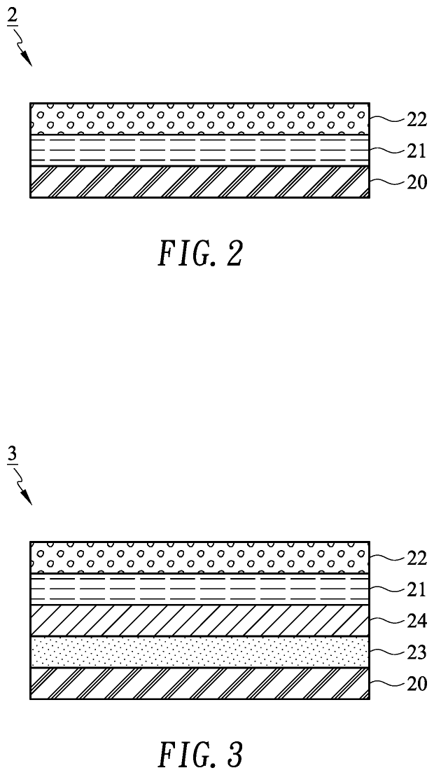

FIG. 2 is a schematic cross-sectional view showing a hot melt tape 2 in accordance with a first embodiment of the present invention. In this embodiment, the hot melt tape 2 includes a base layer 20, an adhesive layer 21 located on the upper surface of the base layer 20, and an anti-sticking layer 22 located on the upper surface of the adhesive layer 21.

Referring to FIG. 2, the base layer 20 is made of a material selected from the group consisting of low density polyethylene (LDPE), high density polyethylene (HDPE), linear low density polyethylene (LLDPE), Styrene-ethylene-butylene-styrene (SEBS), polymethyl methacrylate (PMMA), ethylene-vinyl acetate copolymer (EVA), and polypropylene (PP).

Referring to FIG. 2, the composition of the adhesive layer 21 comprises: (1) 70-90 wt % (weight percentage) of styrene-ethylene-butylene-styrene (SEBS), styrene-butadiene-styrene block copolymer (Styrenic Block Copolymer, SBS), styrene-isoprene-styrene block copolymer (SIS), or ethylene-vinyl acetate copolymers (EVA); and (2) 10-30 wt % of tackifier comprising hydrogenated petroleum resin and thermoplastic elastomer.

Referring to FIG. 2, the composition of the anti-sticking layer 22 comprises: (1) 20-40 wt % of wax (e.g., a low density polyethylene wax (LDPE wax), a high density polyethylene wax (HDPE wax), or a polypropylene wax (PP wax)); (2) 50-70 wt % of low density polyethylene (LDPE), high density polyethylene (HDPE), linear low density polyethylene (LLDPE), styrene ethylene butylene styrene (SEBS), polymethyl methacrylate (PMMA), polypropylene (PP), or ethylene vinyl acetate (EVA); and (3) 10-30 wt % of antistatic agent. The thickness of the anti-sticking layer 22 is usually 10 μm or less, preferably 5 μm or less.

Referring to FIG. 2, in this embodiment, the manufacturing of the hot melt tape 2 is to co-extrude the materials of the base layer 20, the adhesive layer 21, and the anti-sticking layer 22 after the materials are provided. Accordingly, the base layer 20, the adhesive layer 21, and the anti-sticking layer 22 are simultaneously formed by the co-extrusion process. None of layers of the hot melt tape 2 is made by coating or lamination process.

FIG. 3 is a schematic cross-sectional view of a hot melt tape 3 according to a second embodiment of the present invention. In this embodiment, the hot melt tape 3 includes a base layer 20, a connecting layer 23 located on the upper surface of the base layer 20, an intermediate layer 24 located on the upper surface of the connecting layer 23, an adhesive layer 21 located on the upper surface of the intermediate layer 24, and an anti-sticking layer 22 located on the upper surface of the adhesive layer 21.

Referring to FIG. 3, the base layer 20, the adhesive layer 21, and the anti-sticking layer 22 are may respectively have the same composition as those of the same reference numbers described in the first embodiment. The composition of the connecting layer 23 comprises: (1) 50-90 wt % of low-density polymer Ethylene (LDPE), high density polyethylene (HDPE), linear low density polyethylene (LLDPE), styrene-ethylene-butylene-styrene (SEBS), polymethyl methacrylate (PMMA), ethylene vinyl acetate (EVA), or polypropylene (PP); and (2) 10-50 wt % of graft polymers, such as SEBS-graft-maleic anhydride (SEBS-g-MA), polyethylene-graft-maleic anhydride (PE-g-MA), Polypropylene-graft-maleic anhydride (PP-g-MA), wherein the degree of grafting (DOG) of maleic anhydride is 0.1-3%.

Referring to FIG. 3, the intermediate layer 24 is made of a material selected from the group consisting of low density polyethylene (LDPE), high density polyethylene (HDPE), linear low density polyethylene (LLDPE), styrene-ethylene-butylene-styrene (SEBS), polymethyl methacrylate (PMMA), ethylene vinyl acetate (EVA), and polypropylene (PP).

Referring to FIG. 3, in this embodiment, the manufacturing of the hot melt tape 3 is to co-extrude the materials of the base layer 20, the connecting layer 23, the intermediate layer 24, the adhesive layer 21, and the anti-sticking layer 22 after the materials are provided. Accordingly, the base layer 20 and other functional layers are simultaneously formed by the co-extrusion process. None of layers of the hot melt tape 3 is made by coating or lamination process.

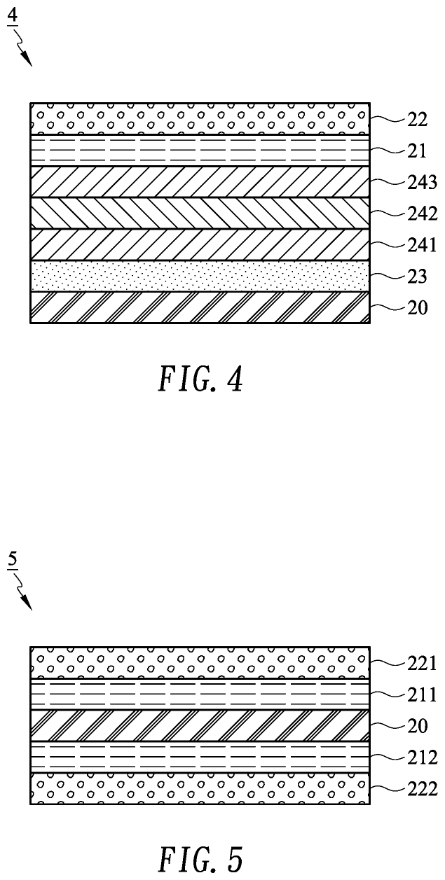

FIG. 4 is a schematic cross-sectional view of a hot melt tape 4 according to a third embodiment of the present invention. In this embodiment, the hot melt tape 4 includes a base layer 20, a connecting layer 23 located on the upper surface of the base layer 20, a first intermediate layer 241 located on the upper surface of the connecting layer 23, a second intermediate layer 242 located on the upper surface of the first intermediate layer 241, a third intermediate layer 243 located on the upper surface of the second intermediate layer 242, an adhesive layer 21 located on the upper surface of the third intermediate layer 243, and an anti-sticking layer 22 located on the upper surface of the adhesive layer 21.

Referring to FIG. 4, the base layer 20, the adhesive layer 21, the anti-sticking layer 22, and the connecting layer 23 may respectively have the same composition as those of the same reference numbers described in the first and second embodiments. The first intermediate layer 24, the second intermediate layer 25, and the third intermediate layer 26 may be respectively made of a material selected from the group consisting of low density polyethylene (LDPE), high density polyethylene (HDPE), linear low density polyethylene (LLDPE), styrene-ethylene-butylene-styrene (SEBS), polymethyl methacrylate (PMMA), ethylene vinyl acetate (EVA), and polypropylene (PP). The first intermediate layer 24, the second intermediate layer 25, and the third intermediate layer 26 may be made of the same or different materials.

Referring to FIG. 4, in this embodiment, the manufacturing of the hot melt tape 4 is to co-extrude the materials of the base layer 20, the connecting layer 23, the first intermediate layer 241, the second intermediate layer 242, the third intermediate layer 243, the adhesive layer 21, and the anti-sticking layer 22 after the materials are provided. Accordingly, the base layer 20 and all other functional layers are simultaneously formed by the co-extrusion process. None of layers of the hot melt tape 4 is made by coating or lamination process.

FIG. 5 is a schematic cross-sectional view of a hot melt tape 5 according to a fourth embodiment of the present invention. In this embodiment, the hot melt tape 5 includes a base layer 20, a first adhesive layer 211 located on the upper surface of the base layer 20, a first anti-sticking layer 221 located on the upper surface of the first adhesive layer 211, a second adhesive layer 212 on the lower surface of the base layer 20, and a second anti-sticking layer 222 on the lower surface of the second adhesive layer 212.

Referring to FIG. 5, the base layer 20 may have same composition as that of the same reference number described in the first embodiment. The composition of the first adhesive layer 211 and the second adhesive layer 212 may comprise: (1) 70-90 wt % of styrene-ethylene-butylene-styrenes (SEBS), styrene-butadiene-styrene block copolymers (SBS), or styrene-isoprene-styrene block copolymer (SIS); and (2) 10-30 wt % of tackifier comprising hydrogenated petroleum resin and thermoplastic elastomer. According to the requirements, the first adhesive layer 211 and the second adhesive layer 212 may have the same or different compositions.

Referring to FIG. 5, the composition of the first anti-sticking layer 221 and the second anti-sticking layer 222 respectively comprises: (1) 20-40 wt % of wax (e.g., a low density polyethylene wax (LDPE wax), a high density polyethylene wax (HDPE wax), or a polypropylene wax (PP wax)); (2) 50-70 wt % of low density polyethylene (LDPE), high density polyethylene (HDPE), linear low density polyethylene (LLDPE), styrene ethylene butylene styrene (SEBS), polymethyl methacrylate (PMMA), polypropylene (PP), or ethylene vinyl acetate (EVA); and (3) 10-30 wt % of antistatic agent. The thickness of the first anti-sticking layer 221 and the second anti-sticking layer 222 is usually 10 μm or less, preferably 5 μm or less. According to requirements, the first anti-sticking layer 221 and the second anti-sticking layer 222 may have the same or different compositions.

Referring to FIG. 5, in this embodiment, the manufacturing of the hot melt tape 5 is to co-extrude the materials of the second anti-sticking layer 222, the second adhesive layer 212, the base layer 20, the first adhesive layer 211, and the first anti-sticking layer 222 after the materials are provided. Accordingly, the base layer 20 and all other functional layers are simultaneously formed by the co-extrusion process. None of layers of the hot melt tape 5 is made by coating or lamination process.

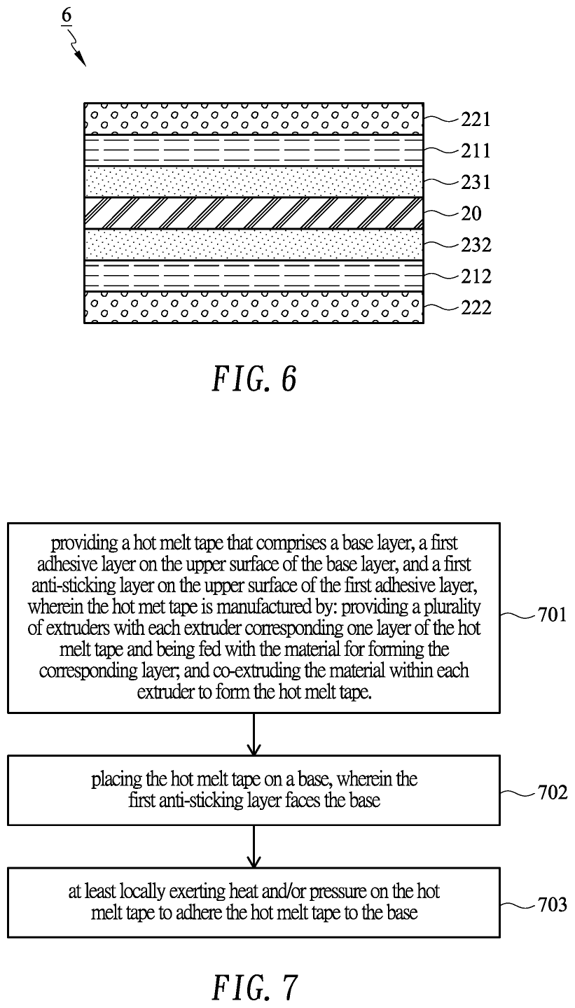

FIG. 6 is a schematic cross-sectional view of a hot melt tape 6 according to a fifth embodiment of the present invention. In this embodiment, the hot melt tape 6 includes a base layer 20, a first connecting layer 231 located on the upper surface of the base layer 20, a first adhesive layer 211 located on the upper surface of the first connecting layer 231, a first anti-sticking layer 221 located on the upper surface of the first adhesive layer 211, a second connecting layer 232 located on the lower surface of the base layer 20, a second adhesive layer 212 located on the lower surface of the second connecting layer 232, and a second anti-sticking layer 222 located on the lower surface of the second adhesive layer 212.

Referring to FIG. 6, the base layer 20, the first adhesive layer 211, the second adhesive layer 212, the first anti-sticking layer 221, and the second anti-sticking layer may respectively have the same composition as those of the same reference numbers described in the fourth embodiment. The composition of the first connecting layer 231 and the second connecting layer 232 respectively comprises: (1) 50-90 wt % of low-density polymer Ethylene (LDPE), high density polyethylene (HDPE), linear low density polyethylene (LLDPE), styrene-ethylene-butylene-styrene (SEBS), polymethyl methacrylate (PMMA), ethylene vinyl acetate (EVA), or polypropylene (PP); and (2) 10-50 wt % of graft polymers, such as SEBS-graft-maleic anhydride (SEBS-g-MA), polyethylene-graft-maleic anhydride (PE-g-MA), Polypropylene-graft-maleic anhydride (PP-g-MA), wherein the degree of grafting (DOG) of maleic anhydride is 0.1-3%. According to requirements, the first connecting layer 231 and the second connecting layer 232 may have the same or different compositions.

In some embodiments, the hot melt tapes provided by the present invention can withstand high temperature above 85° C. The experiment results show that the provided hot melt tapes reveal good anti-sticking properties at 85° C.

In some embodiments, the hot melt tapes provided by the present invention are insoluble in water or hot water.

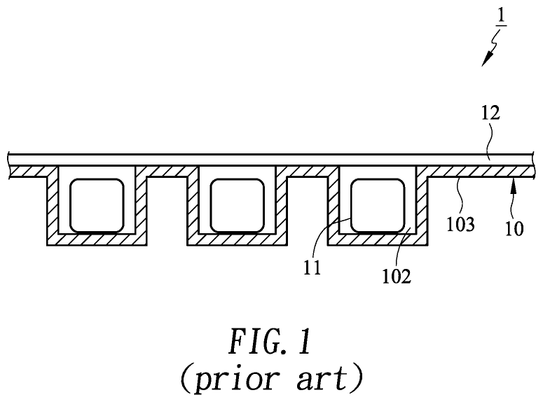

It should be noted that the provided hot melt tapes are not limited to the structures shown in FIGS. 2-6, and numerous other modifications and variations may be devised without departing from the scope of the present disclosure. In some embodiments, the provided hot melt tapes of this invention may be applied, but is not limited to, the packaging configuration 1 as shown in FIG. 1.

FIG. 7 is flow chart showing a method of manufacturing and using a hot melt tape in accordance with an embodiment of the present invention. Referring to step 701, a hot melt tape is provided with a base layer, a first adhesive layer on the upper surface of the base layer, and a first anti-sticking layer on the upper surface of the first adhesive layer, wherein the hot met tape is manufactured by: providing a plurality of extruders (in this example, three extruders in total) with each extruder corresponding one layer of the hot melt tape and being fed with the material for forming the corresponding layer; and co-extruding the material within each extruder to form the hot melt tape. Referring to step 702, the hot melt tape is placed on a base, wherein the first anti-sticking layer faces the base. Referring to step 703, heat and/or pressure is at least locally applied on the hot melt tape to adhere the hot melt tape to the base. By applying heat and/or pressure, the first anti-sticking layer and the first adhesive layer will interact to make the outer surface of the hot melt tape moderately tacky. A conventional release film is unnecessary.

The method of FIG. 7 takes the hot melt tape 2 of FIG. 2 as an example, but it can also be applied to the hot melt tapes of FIGS. 3-6. For example, taking the seven-layer hot melt tape 6 of FIG. 6 as an example, first, the materials for forming the second anti-sticking layer 222, the second adhesive layer 212, the second connecting layer 232, the base layer 20, the first connecting layer 231, the first adhesive layer 211, and the first anti-sticking layer 221 are respectively prepared. For example, the material for forming each layer are mixed and granulated by a twin-screw extruder, and the material particles of each layer are dried at 90° C. for use. Next, the granulated raw materials for each layer are respectively fed to one corresponding extruder, and each extruder is set to a suitable temperature for the corresponding material. The extruder may include, but is not limited to, a single screw extruder. The material in each extruder is gradually melted, and the seven molten polymers then flow into a circular seven-layer screw die to form a seven-layered cylindrical molten film, which then be melted to a tubular film at the outlet of the screw die. A haul device is used to draw the tubular film and air is introduced in the screw die to blow the tubular film, and the diameter of the tubular film is then increased. The rollers of the haul device are to flatten the tubular film to a flat film (two pieces). After cooling the flat film is slit into two separated pieces of film, and each single piece film can be cut to obtain desired length and width.

The hot melt tapes of this invention provide excellent anti-stick properties by a structure having an adhesive layer and an anti-sticking layer on one side or both sides. In addition, the manufacturing of the hot melt tape has high yield, does not require an additional coating process, and greatly reduce the emission of volatile organic compounds.

Although specific embodiments have been illustrated and described, it will be appreciated by those skilled in the art that various modifications may be made without departing from the scope of the present invention, which is intended to be limited solely by the appended claims.

What is claimed is:

1. A hot melt tape, comprising:
a base layer;
a first adhesive layer on the base layer; and
a first anti-sticking layer being attached to an upper surface of the first adhesive layer;
wherein the composition of the first adhesive layer comprises: (1) 70-90 wt % of styrene-ethylene-butylene-styrene (SEBS), styrene-butadiene-styrene block copolymer (SBS), or styrene-isoprene-styrene block copolymer (SIS); and (2) 10-30 wt % of tackifier comprising hydrogenated petroleum resin and thermoplastic elastomer; and
the composition of the first anti-sticking layer comprises: (1) 20-40 wt % of wax; (2) 50-70 wt % of low density polyethylene (LDPE), high density polyethylene (HDPE), linear low density polyethylene (LLDPE), styrene ethylene butylene styrene (SEBS), polymethyl methacrylate (PMMA), polypropylene (PP), or ethylene vinyl acetate (EVA); and (3) 10-30 wt % of antistatic agent.

2. The hot melt tape as recited in claim 1, further comprising:
a connecting layer being attached to an upper surface of the base layer; and
an intermediate layer being attached to an upper surface of the connecting layer;
wherein the first adhesive layer is attached to an upper surface of the intermediate layer, and the composition of the connecting layer comprises: (1) 50-90 wt % of low-density polymer Ethylene (LDPE), high density polyethylene (HDPE), linear low density polyethylene (LLDPE), styrene-ethylene-butylene-styrene (SEBS), polymethyl methacrylate (PMMA), ethylene vinyl acetate (EVA), or polypropylene (PP); and (2) 10-50 wt % of maleic anhydride grafted polymer, wherein the degree of grafting (DOG) of maleic anhydride is 0.1-3%; and
the intermediate layer is made of a material selected from the group consisting of low density polyethylene (LDPE), high density polyethylene (HDPE), linear low density polyethylene (LLDPE), styrene-ethylene-butylene-styrene (SEBS), polymethyl methacrylate (PMMA), ethylene vinyl acetate (EVA), and polypropylene (PP).

3. The hot melt tape as recited in claim 1, further comprising:
a connecting layer being attached to an upper surface of the base layer; and
a first intermediate layer being attached to an upper surface of the connecting layer;
a second intermediate layer being attached to an upper surface of the first intermediate layer; and
a third intermediate layer being attached to an upper surface of the second intermediate layer;
wherein the first adhesive layer is attached to an upper surface of the third intermediate layer, and the first intermediate layer, the second intermediate layer, and the third intermediate layer are respectively made of a material selected from the group consisting of low density polyethylene (LDPE), high density polyethylene (HDPE), linear low density polyethylene (LLDPE), styrene-ethylene-butylene-styrene (SEBS), polymethyl methacrylate (PMMA), ethylene vinyl acetate (EVA), and polypropylene (PP); and
the composition of the connecting layer comprises: (1) 50-90 wt % of low-density polymer Ethylene (LDPE), high density polyethylene (HDPE), linear low density polyethylene (LLDPE), styrene-ethylene-butylene-styrene (SEBS), polymethyl methacrylate (PMMA), ethylene vinyl acetate (EVA), or polypropylene (PP); and (2) 10-50 wt % of maleic anhydride grafted polymer, wherein the degree of grafting (DOG) of maleic anhydride is 0.1-3%.

4. The hot melt tape as recited in claim 1, further comprising:
a second adhesive layer being attached to a lower surface of the base layer; and
a second anti-sticking layer being attached to a lower surface of the second adhesive layer;
wherein the composition of the second adhesive layer comprises: (1) 70-90 wt % of styrene-ethylene-butylene-styrene (SEBS), styrene-butadiene-styrene block copolymer (SBS), or styrene-isoprene-styrene block copolymer (SIS); and (2) 10-30 wt % of tackifier comprising hydrogenated petroleum resin and thermoplastic elastomer; and
the composition of the second anti-sticking layer comprises: (1) 20-40 wt % of wax; (2) 50-70 wt % of low density polyethylene (LDPE), high density polyethylene (HDPE), linear low density polyethylene (LLDPE), styrene ethylene butylene styrene (SEBS), polymethyl methacrylate (PMMA), polypropylene (PP), or ethylene vinyl acetate (EVA); and (3) 10-30 wt % of antistatic agent.

5. The hot melt tape as recited in claim 1, further comprising:
a first connecting layer being attached to an upper surface of the base layer, the first adhesive layer being attached to an upper surface of the first connecting layer;
a second connecting layer being attached to a lower surface of the base layer;
a second adhesive layer being attached to a lower surface of the second connecting layer; and
a second anti-sticking layer being attached to a lower surface of the second adhesive layer;
wherein the composition of the second adhesive layer comprises: (1) 70-90 wt % of styrene-ethylene-butylene-styrene (SEBS), styrene-butadiene-styrene block copolymer (SBS), or styrene-isoprene-styrene block copolymer (SIS); and (2) 10-30 wt % of tackifier comprising hydrogenated petroleum resin and thermoplastic elastomer;
the composition of the second anti-sticking layer comprises: (1) 20-40 wt % of wax; (2) 50-70 wt % of low density polyethylene (LDPE), high density polyethylene (HDPE), linear low density polyethylene (LLDPE), styrene ethylene butylene styrene (SEBS), polymethyl methacrylate (PMMA), polypropylene (PP), or ethylene vinyl acetate (EVA); and (3) 10-30 wt % of antistatic agent; and
the composition of the first connecting layer and the second connecting layer respectively comprises: (1) 50-90 wt % of low-density polymer Ethylene (LDPE), high density polyethylene (HDPE), linear low density polyethylene (LLDPE), styrene-ethylene-butylene-styrene (SEBS), polymethyl methacrylate (PMMA), ethylene vinyl acetate (EVA), or polypropylene (PP); and (2) 10-50 wt % of maleic anhydride grafted polymer, wherein the degree of grafting (DOG) of maleic anhydride is 0.1-3%.

6. The hot melt tape as recited in claim 1, wherein the hot melt tape can withstand high temperature above 85° C.

7. The hot melt tape as recited in claim 1, wherein the first anti-sticking layer has a thickness of equal to or less than 10 μm.

8. The hot melt tape as recited in claim 4, wherein the second anti-sticking layer has a thickness of equal to or less than 10 μm.

9. The hot melt tape as recited in claim 5, wherein the second anti-sticking layer has a thickness of equal to or less than 10 μm.

10. A method of using a hot melt tape, comprising:
providing a hot melt tape that comprises a base layer, a first adhesive layer on an upper surface of the base layer, and a first anti-sticking layer attached to an upper surface of the first adhesive layer, wherein the hot met tape is manufactured by: providing a plurality of extruders with each extruder corresponding one layer of the hot melt tape and being fed with the material for forming the corresponding layer; and co-extruding the material within each extruder to form the hot melt tape;
placing the hot melt tape on a base, wherein the first anti-sticking layer faces the base; and
at least locally exerting heat and/or pressure on the hot melt tape to adhere the hot melt tape to the base.

11. The method as recited in claim 10, wherein the composition of the first adhesive layer comprises: (1) 70-90 wt % of styrene-ethylene-butylene-styrene (SEBS), styrene-butadiene-styrene block copolymer (SBS), or styrene-isoprene-styrene block copolymer (SIS); and (2) 10-30 wt % of tackifier comprising hydrogenated petroleum resin and thermoplastic elastomer; and
the composition of the first anti-sticking layer comprises: (1) 20-40 wt % of wax; (2) 50-70 wt % of low density polyethylene (LDPE), high density polyethylene (HDPE), linear low density polyethylene (LLDPE), styrene ethylene butylene styrene (SEBS), polymethyl methacrylate (PMMA), polypropylene (PP), or ethylene vinyl acetate (EVA); and (3) 10-30 wt % of antistatic agent.

12. The method as recited in claim 10, wherein the base comprises one or more recesses with each to place an object, and the hot melt tape is locally heated and/or pressed on a flat portion of the base.

13. The method as recited in claim 10, wherein the hot melt tape further comprises:
a connecting layer being attached to an upper surface of the base layer; and
an intermediate layer being attached to an upper surface of the connecting layer;
wherein the first adhesive layer is attached to an upper surface of the intermediate layer.

14. The method as recited in claim 10, wherein the hot melt tape further comprises:
a connecting layer being attached to an upper surface of the base layer;
a first intermediate layer being attached to an upper surface of the connecting layer;
a second intermediate layer being attached to an upper surface of the first intermediate layer; and
a third intermediate layer being attached to an upper surface of the second intermediate layer;
wherein the first adhesive layer is attached to an upper surface of the third intermediate layer.
